(19) United States
(12) Patent Application Publication
(10) Pub. No.: US 2009/0300537 A1
(43) Pub. Date: Dec. 3, 2009

(54) Method and system for changing format for displaying information on handheld device

(76) Inventor: Kenneth J. Park, Cathlamet, WA (US)

Correspondence Address: SHARP LABORATORIES OF AMERICA, INC., 1320 PEARL ST., SUITE 228, BOULDER, CO, 80302, US

(21) Appl. No.: 12/154,702

(22) Filed: May 27, 2008

(51) Int. Cl. G06F 3/048; G01S 1/00

(52) U.S. Cl. 715/778; 342/357.12

(57) ABSTRACT

A method and system for changing a display format for information rendered on a handheld device based at least in part on a velocity of the handheld device recognizes that when the velocity of the handheld device that is optimally held by a stationary user in both hands in a horizontal orientation exceeds a predetermined threshold, it is generally indicative that the handheld device is being held by a mobile user in one hand in a vertical orientation. Accordingly, upon determining that the velocity of the handheld device exceeds the predetermined threshold, information rendered on the handheld device is reoriented from a landscape orientation to a portrait orientation so that the information is oriented correctly from the perspective of the mobile user. Thereafter, upon determining that the velocity of the handheld device is below the predetermined velocity threshold, the information rendered on the handheld device is reoriented from the portrait orientation to the landscape orientation so that the information is oriented correctly from the perspective of a stationary user.

### BACKGROUND OF THE INVENTION

The present invention relates to improving the ease of use of handheld devices and, more particularly, to improving the ease of use of a handheld device that is optimally held by both hands when such handheld device is being held by one hand.

Some handheld devices, such as some Internet appliances, personal data assistants (PDA), digital cameras and gaming devices, are designed to be held in a horizontal orientation by a stationary user. These handheld devices have a width that exceeds their height. Along the width is a display that is typically wider than it is tall. To the left and/or right side of the display are controls and/or buttons. The stationary user uses his or her left hand to work controls and/or buttons on the left side of the display and his or her right hand to work controls and/or buttons on the right side of the display. Information is rendered on the display in a landscape orientation that is correct from the perspective of the stationary user.

When the user is mobile, for example, driving, biking or walking, the user often cannot hold the handheld device in the intended horizontal orientation. Instead, the mobile user typically holds the handheld device in one hand in a vertical orientation. However, information on the display continues to be rendered in a landscape orientation. Thus, in the case where the user is holding the handheld device in a vertical orientation wherein what was formerly the right side of the handheld device is now the top, the orientation of information on the display is incorrect (e.g. appears rotated at a ninety degree angle) from the perspective of the mobile user.

### SUMMARY OF THE INVENTION

The present invention provides a method and system for changing a display format for information rendered on a handheld device based at least in part on a velocity of the handheld device. The present invention recognizes that when the velocity of the handheld device that is optimally held by a stationary user in both hands in a horizontal orientation exceeds a predetermined threshold, it is generally indicative that the handheld device is being held by a mobile user in one hand in a vertical orientation. Accordingly, upon determining that the velocity of the handheld device exceeds the predetermined threshold, information rendered on the handheld device is reoriented from a landscape orientation to a portrait orientation so that the information is oriented correctly from the perspective of the mobile user. Thereafter, upon determining that the velocity of the handheld device is below the predetermined velocity threshold, the information rendered on the handheld device is reoriented from the portrait orientation to the landscape orientation so that the information is oriented correctly from the perspective of a stationary user.

In one aspect of the invention, a handheld device comprises a user interface and a processor communicatively coupled with the user interface, wherein under control of the processor the handheld device reorients information rendered on a display of the user interface based at least in part on a determined velocity of the handheld device.

In some embodiments, the handheld device further comprises a global positioning system (GPS) receiver communicatively coupled with the processor, wherein the processor determines the velocity based at least in part on information received from the GPS receiver.

In some embodiments, under control of the processor the handheld device reorients the information based at least in part on a comparison of the determined velocity with a predetermined velocity threshold.

In some embodiments, the reorientation comprises a change from a landscape orientation to a portrait orientation.

In some embodiments, in the portrait orientation the bottom of the information is aligned with a side of the handheld device preselected by a user of the handheld device.

In some embodiments, the reorientation comprises a change from a portrait orientation to a landscape orientation.

In some embodiments, the portrait orientation and the landscape orientation are at a ninety degree offset.

In some embodiments, under control of the processor the handheld device continually determines velocity and whether the information requires reorientation.

In some embodiments, under control of the processor the handheld device reorients the information from a landscape orientation to a portrait orientation based at least in part on a determination that a first determined velocity is above a predetermined velocity threshold and reorients information from the portrait orientation to the landscape orientation based at least in part on a determination that a second determined velocity is below the predetermined velocity threshold.

In some embodiments, under control of the processor the handheld device reorients the information from a landscape orientation to a portrait orientation based at least in part on a determination that a first determined velocity is above a first predetermined velocity threshold and reorients information from the portrait orientation to the landscape orientation based at least in part on a determination that a second determined velocity is below a second predetermined velocity threshold, wherein the first threshold is higher than the second threshold.

In some embodiments, under control of the processor the handheld device reorients the information from a landscape orientation to a portrait orientation based at least in part on a determination that a determined velocity is above a predetermined velocity threshold and sets a hysteresis timer that inhibits reorientation of information from the portrait orientation to the landscape orientation for a predetermined time.

In another aspect of the invention, a handheld device comprises a user interface and a processor communicatively coupled with the user interface, wherein under control of the processor the handheld device changes a display format for information rendered on a display of the user interface based at least in part on a determined velocity of the handheld device.

In yet another aspect of the invention, a method for changing a display format for rendering information on a handheld device comprises the steps of determining a velocity of the handheld device and changing a display format for information rendered on a display of the handheld device based at least in part on the determined velocity.

In some embodiments, the display format is changed from a landscape format to a portrait format.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a handheld device in a horizontal orientation rendering information in a landscape orientation.

FIG. 2 shows the handheld device in a vertical orientation rendering the information in a portrait orientation.

FIG. 3 shows hardware elements of the handheld device.

FIG. 4 shows software elements of the handheld device.

FIG. 5 shows a method for changing a display format for rendering information on a handheld device in some embodiments of the invention.

### DETAILED DESCRIPTION OF A PREFERRED EMBODIMENT

FIG. 1 shows a handheld device 100 in a horizontal orientation rendering information 150 in a landscape orientation. Handheld device 100 may be an Internet appliance, PDA, or digital camera or gaming device, for example. Handheld device 100 is generally designed to be held by a stationary user in both hands in a horizontal orientation. When in a horizontal orientation, the width of handheld device 100 exceeds the height of handheld device 100 and the width of a display 140 on handheld device 100 exceeds the height of display 140. Display 140 may be a liquid crystal display (LCD) or an organic light emitting diode (OLED) display, for example. In some embodiments, display 140 is a touch screen that allows a user of handheld device 100 to input information by touching areas of display 140. At the left side of handheld device 100 are action buttons 110. Action buttons 100 are buttons that can be actuated by the user to cause handheld device 100 to take certain actions, such as return to previous page, advance to next page, increase page size to full screen, reduce page size, power on, power off, zoom-in and zoom-out. At the right side of handheld device 100 are directional controls 120 that can be actuated by the user to navigate display 140 and a selection button 130 that can be actuated by the user to select objects on display 140. In other embodiments, a handheld device may have buttons and/or controls on only one side, or neither side, of its display.

Display 140 renders information 150, which in the example show is an image, in a landscape orientation that is correct from the perspective of a stationary user who is holding wireless device 100 in both hands in a horizontal orientation. While information 150 is shown as an image for illustrative purposes, information rendered on display 140 may include text in the absence of any image, one or more images in the absence of text, or a combination of text and one or more images.

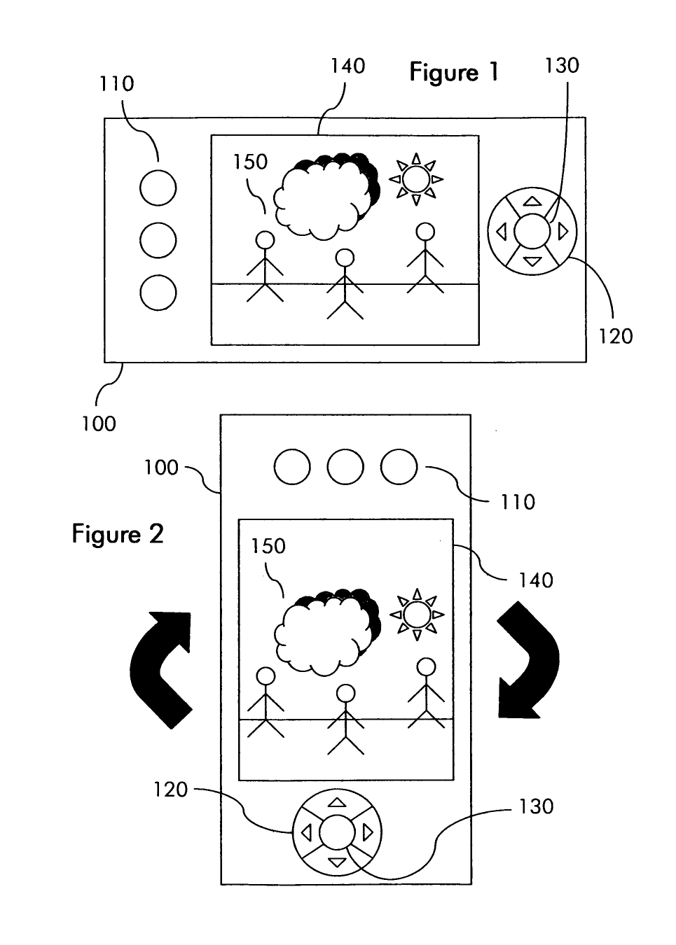

Turning now to FIG. 2, handheld device 100 is shown in a vertical orientation rendering information 150 in a portrait orientation. The vertical orientation of handheld device 100 in FIG. 2 is at a ninety degree offset in the clockwise direction from the horizontal orientation shown in FIG. 1. Handheld device 100 may assume the vertical orientation when, for example, a mobile user who is driving, biking or walking holds handheld device 100 in one hand. Importantly, when handheld device 100 is held in the vertical orientation, information 150 on handheld device 100 is rendered in a portrait format that is correct from the perspective of the mobile user who is holding wireless device 100 in one hand. Information 150 rendered on handheld device 100 in the portrait format of FIG. 2 is at a ninety degree offset in the counterclockwise direction from information 150 rendered on handheld device 100 in the landscape format of FIG. 1. Rendering information 150 in a portrait orientation when handheld device 100 is in the vertical orientation improves the mobile user's ability to understand and manipulate the information being displayed.

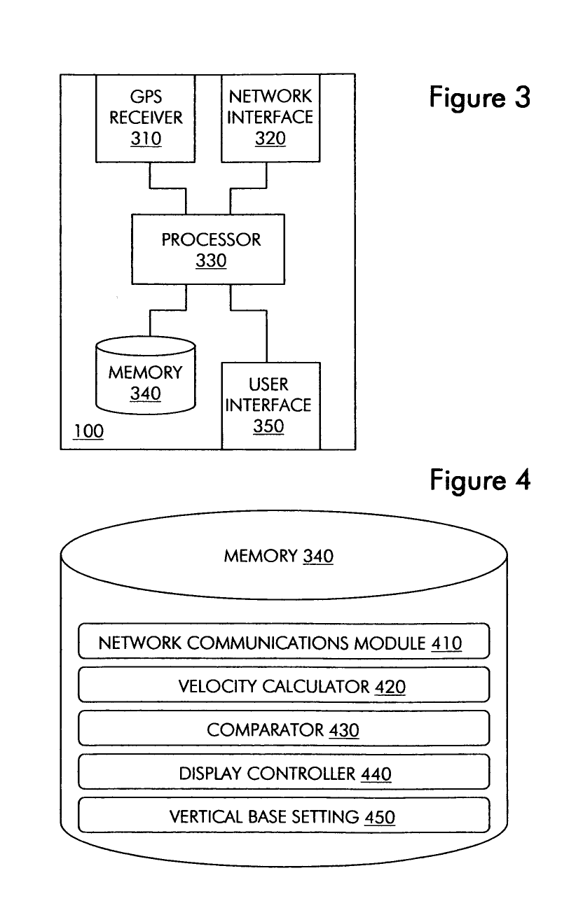

FIG. 3 shows hardware elements of handheld device 100. Handheld device 100 includes a GPS receiver 310, a wireless network interface 320, a memory 340 and a user interface 350, all of which are communicatively coupled with a processor 330. GPS receiver 310 receives signals from GPS satellites, determines locations (e.g. latitude, longitude, altitude) and corresponding times of receipt and passes the location and time information to processor 330. Network interface 320 transmits and receives information on wireless links established with access devices. Information 150 rendered on display 140 (e.g. web pages) may be received via network interface 320. Network interface 320 may be, for example, a cellular network interface, a wireless local area network (e.g. Wi-Fi) interface or a wireless metropolitan or wide area network (e.g. WiMAX) interface. User interface 350 receives inputs from a human user of handheld device 100 via one or more input devices and displays outputs to the member via one or more output devices. Output devices include display 140 and may also include other output devices such as speakers. Input devices include action buttons 110, direction buttons 120 and selection button 130 and may also include other input devices such as a finger or stylus-operated touch screen capability on display 140 and/or a microphone. Processor 330 executes in software operations supported by handheld device 100, including establishment, tear-down and management of wireless links via network interface 320, determining the current velocity of handheld device 100 based on the most recent and one or more earlier locations of handheld device 100 and determining whether to change the display format for information 150 rendered on handheld device 100 based on the determined velocity. In some embodiments the current velocity and display format change determinations are performed continually, either in a continuous loop or periodically. Memory 440 stores software executable by processor 330. Memory 340 includes one or more random access memories (RAM) and one or more read only memories (ROM).

FIG. 4 shows software elements of handheld device 100 to include a network communications module 410, a velocity calculator 420, a comparator 430 and an orientation controller 440. Communications module 410 has instructions executable by processor 330 to establish, manage and tear-down connections to access devices via network interface 320.

Velocity calculator 420 has instructions executable by processor 330 to determine the current velocity of handheld device 100 based on locations of handheld device 100 and corresponding times received by processor 330 from GPS receiver 310. Velocity calculator 420 may, for example, calculate the velocity of handheld device 100 as the distance between the current and immediately preceding location of handheld device 100 divided by the elapsed time between the current and immediately preceding location determinations. In some embodiments, the elapsed time may be determined by a local clock rather than time information received by processor 330 from GPS receiver 310.

Comparator 430 has instructions executable by processor 330 to determine whether information should be rendered on display 140 in a landscape format or a portrait format and notifies display controller 440. Comparator 430 compares the current velocity of handheld device 100 determined by velocity calculator 420 with a predetermined velocity threshold. If the current velocity is at or above the predetermined velocity threshold, comparator 430 concludes that information should be rendered in portrait format. If the current velocity is below the predetermined velocity threshold, comparator 430 concludes that information should be rendered in landscape format. Comparator 430 compares the display format indicated by the threshold comparison with the current display format and if there is nonconformance issues a change notification to display controller 440 indicating to change the current display format to correspond with the display format indicated in the threshold comparison. The predetermined velocity threshold may be set to a speed indicative that handheld device 100 is moving, at a minimum, at a walking pace (e.g. 3 miles per hour).

In some embodiments, separate predetermined velocity thresholds may be defined for entry into and exit from portrait format to prevent rapid “ping-ponging” between landscape and portrait formats. For example, a portrait format entry velocity threshold may be set to a first velocity and a portrait format exit velocity threshold may be set to a second velocity that is lower than the first velocity. When the current velocity is at or above the portrait format entry velocity threshold (e.g. 3 miles per hour), comparator 430 concludes that information should be rendered in portrait format and maintains that view until the current velocity falls below the portrait format exit velocity threshold (e.g. 1 mile per hour), at which time comparator 430 concludes that information should once again be rendered in landscape format.

In other embodiments, a single predetermined velocity threshold and hysteresis may be used to prevent rapid “ping-ponging” between landscape and portrait formats. For example, when the current velocity is at or above the predetermined velocity threshold, comparator 430 concludes that information should be rendered in portrait format and sets a hysteresis timer. A return to landscape format is prevented until the hysteresis timer expires even if the current velocity drops below the predetermined velocity threshold prior to expiration of the hysteresis timer.

Display controller 440 has instructions executable by processor 330 to render information on display 140 in a display format indicated in the most recent change notification received from comparator 430. When display controller 440 receives a change notification, display controller 440 immediately and without user intervention reorients information 150 rendered on display 140 to the display format indicated in the change notification and renders any further information on display 140 in the display format indicated in the change notification (until the next change notification is received). After power-up and until a change notification is received, display controller 440 renders information in a landscape format. In other embodiments, handheld device 100 alerts the user via an audio or visual alert that a change in the display format is imminent. In some of these embodiments, the user must accept the change through user input (e.g. pressing a button) before the change takes effect.

Memory 340 also includes a vertical base setting 450. Vertical base setting 450 identifies whether the left or right side of handheld device 100 when held in a horizontal orientation should be presumed to be the bottom of handheld device 100 when held in a vertical orientation. When display controller 440 renders information on display 140 in portrait format, orientation controller 440 determines from vertical base setting 450 whether display controller 440 should align the bottom of the information with the left side or the right side of handheld device 100. For example, returning momentarily to FIG. 2, the bottom of information 150 is aligned with the right side of handheld device 110, reflecting a “right side” vertical base setting. Vertical base setting 450 is user configurable. The default setting is “right side” as a right handed person who is driving, biking, walking etc. may be inclined to rotate handheld device 100 clockwise from a horizontal orientation in which handheld device 100 is held with both hands into a vertical orientation in which handheld device 100 is held only in the right hand.

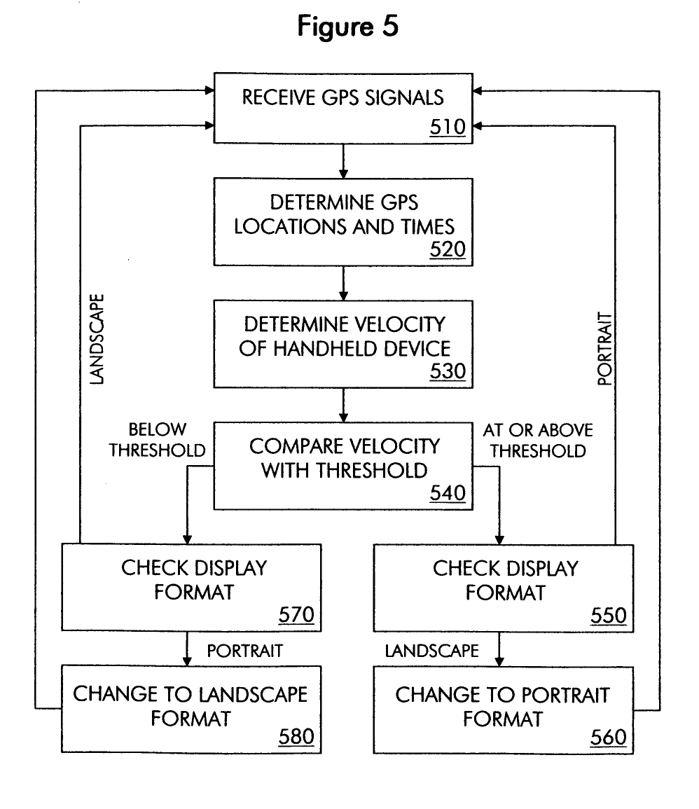

FIG. 5 shows a method for changing a display format for rendering information 150 on handheld device 100 in some embodiments of the invention. GPS signals are received on GPS receiver 310 from GPS satellites (510). GPS receiver 310 determines the location of handheld device 100 at different times and transmits the locations and times to processor 330 (520). Velocity calculator 420 determines the current velocity of handheld device 100 based on the locations and times (530). Comparator 430 compares the current velocity with a predetermined velocity threshold (540). If the current velocity is at or above the predetermined velocity threshold, comparator 430 checks the current display format for information rendered on handheld device 100 (550). If the current display format is portrait, a change in the display format is not required and the flow returns to Step 510. If, however, the current display format for information rendered on handheld device 100 is landscape, a change in the display format is required. Comparator 430 notifies display controller 440, which implements the change to portrait format causing information 150 and any further information received until the next change notification to be rendered in a portrait orientation (560), whereafter the flow returns to Step 510. If the current velocity is below the predetermined velocity threshold, comparator 430 checks the current display format for information rendered on handheld device 100 (570). If the current display format is landscape, a change in the display format is not required and the flow returns to Step 510. If, however, the current display format for information rendered on handheld device 100 is portrait, a change in the display format is required. Comparator 430 notifies display controller 440, which implements the change to landscape format causing information 150 and any further information received until the next change notification to be rendered in a landscape orientation (560), whereafter the flow returns to Step 510.

It will be appreciated by those of ordinary skill in the art that the invention can be embodied in other specific forms without departing from the spirit or essential character hereof. For example, in other embodiments velocity is determined using location information obtained by a system other than GPS, such as a different radio navigation satellite system or a terrestrial based location system. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A handheld device, comprising:
a user interface; and
a processor communicatively coupled with the user interface, wherein under control of the processor the handheld device reorients information rendered on a display of the user interface based at least in part on a determined velocity of the handheld device.

2. The handheld device of claim 1 further comprising a global positioning system (GPS) receiver communicatively coupled with the processor, wherein the processor determines the velocity based at least in part on information received from the GPS receiver.

3. The handheld device of claim 1, wherein under control of the processor the handheld device reorients the information based at least in part on a comparison of the determined velocity with a predetermined velocity threshold.

4. The handheld device of claim 1, wherein the reorientation comprises a change from a landscape orientation to a portrait orientation.

5. The handheld device of claim 4, wherein in the portrait orientation the bottom of the information is aligned with a side of the handheld device preselected by a user of the handheld device.

6. The handheld device of claim 1, wherein the reorientation comprises a change from a portrait orientation to a landscape orientation.

7. The handheld device of claim 6, wherein the portrait orientation and the landscape orientation are at a ninety degree offset.

8. The handheld device of claim 1, wherein under control of the processor the handheld device continually determines velocity and whether the information requires reorientation.

9. The handheld device of claim 1, wherein under control of the processor the handheld device reorients the information from a landscape orientation to a portrait orientation based at least in part on a determination that a first determined velocity is above a predetermined velocity threshold and reorients information from the portrait orientation to the landscape orientation based at least in part on a determination that a second determined velocity is below the predetermined velocity threshold.

10. The handheld device of claim 1, wherein under control of the processor the handheld device reorients the information from a landscape orientation to a portrait orientation based at least in part on a determination that a first determined velocity is above a first predetermined velocity threshold and reorients information from the portrait orientation to the landscape orientation based at least in part on a determination that a second determined velocity is below a second predetermined velocity threshold, wherein the first threshold is higher than the second threshold.

11. The handheld device of claim 1, wherein under control of the processor the handheld device reorients the information from a landscape orientation to a portrait orientation based at least in part on a determination that a determined velocity is above a predetermined velocity threshold and sets a hysteresis timer that inhibits reorientation of information from the portrait orientation to the landscape orientation for a predetermined time.

12. A handheld device, comprising:
a user interface; and
a processor communicatively coupled with the user interface, wherein under control of the processor the handheld device changes a display format for information rendered on a display of the user interface based at least in part on a determined velocity of the handheld device.

13. The handheld device of claim 12, further comprising a GPS receiver communicatively coupled with the processor, wherein the processor determines the velocity based at least in part on information received from the GPS receiver.

14. The handheld device of claim 12, wherein under control of the processor the handheld device changes the display format based at least in part on a comparison of the determined velocity with a predetermined velocity threshold.

15. The handheld device of claim 12, wherein the change comprises a change from a landscape format to a portrait format.

16. The handheld device of claim 12, wherein the change comprises a change from a portrait format to a landscape format.

17. The handheld device of claim 12, wherein under control of the processor the handheld device continually determines velocity and whether the display format requires changing.

18. The handheld device of claim 12, wherein under control of the processor the handheld device changes the display format from a landscape orientation to a portrait orientation based at least in part on a determination that a first determined velocity is above a predetermined velocity threshold and changes the display format from the portrait orientation to the landscape orientation based at least in port on a determination that a second determined velocity is below a predetermined velocity threshold.

19. A method for changing a display format for rendering information on a handheld device, comprising the steps of:
determining a velocity of the handheld device; and
changing a display format for information rendered on a display of the handheld device based at least in part on the determined velocity.

20. The method of claim 19, wherein the display format is changed from a landscape format to a portrait format.
